(19) United States
(12) Patent Application Publication
(10) Pub. No.: US 2026/0211452 A1
(43) Pub. Date: Jul. 23, 2026

(54) METHOD OF REPORTING EXTERNAL DEVICE STATUS TO USERS

(71) Applicant: DELL PRODUCTS L.P., Round Rock, TX (US)

(72) Inventors: Yung-Sheng Lin, Taoyuan City (TW); Shun-Tang Hsu, Taipei (TW)

(21) Appl. No.: 19/032,068

(22) Filed: Jan. 19, 2025

(51) Int. Cl. G06F 1/16; G06F 11/07; G06F 11/22

(52) U.S. Cl. CPC G06F 1/1632; G06F 11/0751; G06F 11/2221

(57) ABSTRACT

An information handling system may include an embedded controller (EC) that can be configured to manage peripheral devices associated through a docking system. In an embodiment, the EC may sense a signal from the docking system indicating one or more devices associated with the docking system; generate a device table for the one or more associated devices; perform a diagnostic test on the one or more associated devices; update the device table based on results of the diagnostic test; communicate the updated device table to an operating system (OS); and receive a user-entered device selection. In this embodiment, the EC facilitates communication between the selected device and the OS.

### FIELD OF THE DISCLOSURE

The present disclosure generally relates to information handling systems and, more particularly, to an information handling system having an embedded controller (EC) that facilitates reporting of device status to users.

### BACKGROUND

As the value and use of information continue to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use, such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may include an operating system (OS) component and an embedded controller (EC), which can be configured to manage peripheral devices associated through a docking system. In an embodiment, the EC may send communication commands to a docking system to establish connection. The EC may then sense a signal from the docking system in response to the communicated commands. The signal may be representative of associated device IDs, types, status, capabilities, or diagnostic test results. The EC may then generate a device table that includes structured data of the associated devices. The EC may also perform diagnostic tests and update the generated device table based on results of the diagnostic tests. The EC may then communicate the updated device table to the OS for further processing. For example, a user interface (UI) may present options for a device selection. Here, the EC may receive the user-entered selection and facilitate communication between the OS and the selected device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an example computing environment including a docking system that facilitates connection of peripheral devices to an information handling system according to at least one embodiment of the present disclosure;

FIG. 2 is a block diagram of an embedded controller (EC) that generates a device table of peripheral devices according to at least one embodiment of the present disclosure;

FIG. 3 is an example device table that can be generated by the EC according to at least one embodiment of the present disclosure;

FIG. 4 is an example user interface (UI) that displays device selections according to at least one embodiment of the present disclosure;

FIG. 5 is a flow diagram of a method for reporting external devices to users according to at least one embodiment of the present disclosure; and

FIG. 6 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

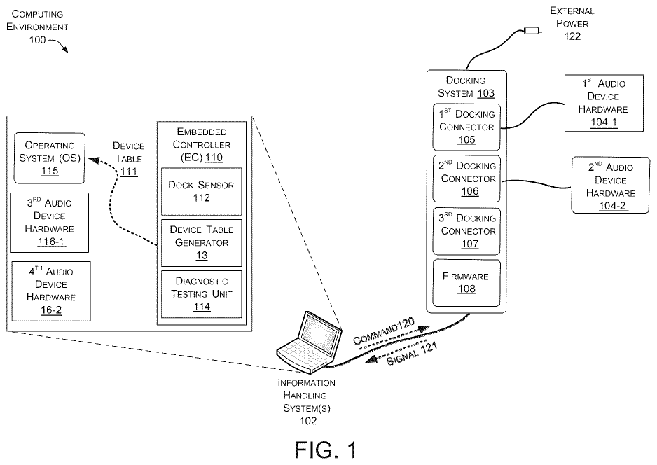

FIG. 1 illustrates an example computing environment 100, according to at least one embodiment of the present disclosure. The computing environment 100 may refer to a collection of hardware, software, and networks that interact to perform and manage computational tasks. In some embodiments, the computing environment 100 includes an information handling system 102 that utilizes a docking system 103 to connect with peripheral devices (e.g., 1^{st} audio device hardware 104-1, 2^{nd} audio device hardware 104-2). The information handling system 102 may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes.

For example, a particular information handling system 102 may represent a computer system, such as a laptop computer, a desktop computer, a computer workstation, a server system, a blade server system, or other rack-mounted computer equipment, such as a storage server, a network server, a network switch/router, or other datacenter computer equipment, or other electronic equipment generally defined, but being characterized as including an integrated EC 110 (or controller) that facilitates seamless operation and user experience via efficient managing of connectivity, status, and selection of associated peripheral devices (e.g., 1^{st} audio device hardware 104-1, 2^{nd} audio device hardware 104-2). The EC 110 may be configured, for example, to generate a device table 111 of these devices and communicate the generated device table 111 to an operating system (OS) 115 component of the information handling system 102 for further processing. The device table 111 may store information or include a data structure to keep track of identification (device ID), status, capabilities, and particular configuration or resource allocation required for proper interaction between the OS 115 and the detected peripheral devices. By sending an updated device table in real time to the OS 115, the EC 110 may facilitate presenting of options to users for the efficient use of these peripheral devices.

In an embodiment, the EC 110 may include a specialized microcontroller that communicates with the docking system 103 to identify and report in real-time the device table 111 of the devices (e.g., 1^{st} audio device hardware 104-1, 2^{nd} audio device hardware 104-2) that are associated with the docking system 103. The EC 110 may be configured to perform this function independently, such as, without receiving an instruction command from the OS 115. In some embodiments, and after establishing communication with the docking system 103, the EC 110 may control and manage connectivity and other functionality of the one or more associated devices by sending a command 120 through the docking system 103. As described herein, the command 120 may be representative of instructions to establish communication with the docking system 103, signals to perform diagnostic tests, signals to attempt reconnection with disconnected devices, signals to initialize the disconnected devices, and execute other instructions or commands to manage and operate the associated devices. The associated devices can include peripheral devices and other devices that are integrated into the information handling system, e.g., 3^{rd} audio device hardware 116-1, 4^{th} audio device hardware 116-2. An example of an embedded controller may include a Baseboard Management Controller (BMC) as described further below.

The EC 110 may use the established communication to generate the device table 111 that can indicate a device identification (ID), device type, status, and other parameters of each of the detected associated devices. For example, in response to the sending of the command 120, the EC 110 may sense a signal 121 that can be parsed to identify device IDs of the 1^{st} audio device hardware 104-1 and the 2^{nd} audio device hardware 104-2. The EC 110 may also derive the device types (e.g., audio, microphone, or a display device) and corresponding capabilities (e.g., stereo, 4K resolution) of these peripheral devices from the signal 121. In an embodiment, the EC 110 may perform diagnostic tests (via command 120) to identify current configurations (e.g., disconnected, passed test, failed test) of these associated devices. In response to a disconnected result, for example, the EC 110 may attempt to reconnect (via command 120) with the particular device for a threshold number of times before updating the device table 111.

For example, in response to a diagnostic testing (via command 120), the signal 121 indicates a disconnected 1^{st} audio device hardware 104-1. Here, the EC 110 may attempt to reconnect with the disconnected 1^{st} audio device hardware 104-1 for three times (threshold number of attempts). Based on results of the attempted reconnection, the EC 110 may update the device table 111 and report the updated device table 111 to the OS 115 for further processing. Alternatively, instead of attempting to reconnect, the EC 110 may initialize the disconnected 1^{st} audio device hardware 104-1 and then perform another diagnostic test (via command 120) before updating the device table 111. For purposes of illustration, the EC 110 may include a dock sensor 112, device table generator 113, and a diagnostic testing unit 114 to sense the signal 121, generate the device table 111, and perform the diagnostic testing, respectively. Generally, the EC 110 may include a memory (not shown) and a processor (not shown) that can implement functionalities of the dock sensor 112, device table generator 113, and the diagnostic testing unit 114.

Dock sensor 112 may include hardware, software, or a combination thereof, that is configured to establish communication with the docking system 103 to detect the peripheral devices. The dock sensor 112 may communicate with the docking system 103 via an interface such as a USB-C, Serial Peripheral Interface (SPI), Inter-Integrated Circuit (I2C), or Thunderbolt™ to detect the connected peripheral devices.

For example, the docking system 103 may use the USB-C or a high-speed Thunderbolt™ to manage or control the 1^{st} audio device hardware 104-1 and the 2^{nd} audio device hardware 104-2 devices. Here, the dock sensor 112 may send a query (e.g., command 120) to the docking system 103 to obtain information about the connected peripheral devices. In a particular embodiment, the dock sensor 112 can send a command request (command 120) to the docking system 103 to directly control these associated peripheral devices. These associated devices can be audio devices, storage devices, display devices, or a combination thereof.

In another example, the dock sensor 112 may communicate with the docking system 103 via dedicated monitor control ports or through General Purpose Input/Output (GPIO) pins configured to detect connection and status of the peripheral devices. For example, the dock sensor 112 communicates the command 120 to the docking system 103 and upon receiving a response (signal 121) from the docking system 103, the dock sensor 112 can directly monitor the signals from the docking system 103, such as the voltage levels or status changes on specific GPIO pins connected to the docking system's ports. For example, when the 1^{st} audio device hardware 104-1 is plugged to a 1^{st} docking connector 105 of the docking system 103, the EC 110 can detect a voltage or signal change via the GPIO pins of the docking system 103.

Device table generator 113 may include a firmware-based component embedded within the EC 110 and configured to generate the device table 111, which includes the structured data for each of the devices that were detected to be associated with the docking system 103. For example, the structured data may include the device IDs or descriptors (e.g., USB device descriptors), configuration settings, and results of the performed diagnostic testing. Without limitation, the configuration settings may include audio codec capabilities or supported formats, (e.g., audio sample rates, resolution), display resolutions, capabilities (e.g., stereo output, storage capacity), and the like. In this example, the dock sensor 112 may retrieve the device descriptors and configuration data (via the signal 121) and communicate the retrieved device descriptors and configuration data to the device table generator 113. In some embodiments, the device table 111 may include the structure data of the 3^{rd} audio device hardware 116-1 and the 4^{th} audio device hardware 116-2 that are integrated into the information handling system 102. Here, the EC 110 may similarly perform diagnostic testing to update the structured data associated with these integrated devices.

Diagnostic testing unit 114 may include a firmware-based component of the EC 110 that is configured to run diagnostic tests on each of the integrated devices, associated peripheral devices, and/or ports of the docking system 103 to assess their corresponding functionality and status. In an embodiment, the diagnostic testing unit 114 may transmit command signals (command 120) to the docking system 103 to verify power-on condition (or power status), integrity of the communication interfaces, and device-specific functionality or configurations. Here, and based on feedback (via signal 121) from the transmitted command 120, the diagnostic testing unit 114 may provide real-time feedback or updates on the status and health of the connected peripheral devices to the device table generator 113 and/or directly to the OS component 115.

For example, for USB-powered audio devices, the diagnostic testing unit 114 may send the command 120 to a USB host controller (not shown) of the docking system 103 to check the status of a connected audio device. Here, the diagnostic testing unit 114 may send a status request command 120 to the USB audio device to confirm whether the USB audio device is powered on. The diagnostic testing unit 114 may also send a command like “PLAY_TONE” to verify if the audio device can transmit and/or receive audio signals. In another example, the diagnostic testing unit 114 can send I2C command 120 for testing audio devices such as microphones. Here, the diagnostic testing unit 114 can send the I2C command 120 to the associated peripheral device, which may be connected to the docking system via I2C protocol. In response to the command 120, the associated peripheral device may respond with a status byte indicating its operational state.

Docking system 103 may include hardware and software that can be configured to connect a variety of peripheral devices to the information handling system 102. For example, a docking connector such as a USB-C (not shown) on a side of the portable information handling system 102 couples to a docking connector (not shown) of the docking system 103. The docking system 103 may serve as a central point for devices such as the 1^{st} audio device hardware 104-1, 2^{nd} audio device hardware 104-2, keyboard (not shown), additional display (not shown), and an external power 122. The docking system 103 may provide an end user interaction with the portable information handling system 102 with the convenience of a desktop system when the information handling system 102 is coupled to the docking system 103. For example, a lid of the portable information handling system 102 can be closed to convert it into a desktop system that interacts with the associated peripherals through docking system 103.

Docking system connectors, such as the 1^{st} docking connector 105, a 2^{nd} docking connector 106, and a 3^{rd} docking connector 107 can include USB-A, analog audio jacks, HDMI, DisplayPort, VGA, or Ethernet. The docking system 103 may also include a Bluetooth module (not shown) to connect to Bluetooth speakers or microphones. The Bluetooth module in the docking system 103 scans for available devices, and, upon detecting a Bluetooth audio device, the docking system 103 may send the signal (signal 121) to the EC 110 with details of the discovered devices (e.g., device ID, type). The communication between the EC 110 and the docking system 103 can then be facilitated via the Bluetooth signal.

In an embodiment, a docking system firmware 108 may facilitate communication with the EC 110 to allow the EC 110 to detect the connection and status of associated devices, retrieve device configurations, and perform diagnostic tests on these associated devices. The firmware 108 may be configured to allow the EC 110 to continuously monitor and interact with the associated peripheral devices to obtain the status, configuration, and health of these associated peripheral devices in real-time.

The firmware 108 may include functional modules (not shown) to identify the connection of the 1^{st} audio device hardware 104-1 and the 2^{nd} audio device hardware 104-2. The firmware 108 may actively monitor all available ports, such as, USB, HDMI, DisplayPort, audio jacks, and the like, for connecting peripheral devices. The firmware 108 may actively check the connection signals from the docking system's ports and upon detecting the connected device (e.g., 1^{st} audio hardware 104-1), the firmware 108 may identify the type of device (e.g., audio device, storage device, display device), capabilities, and other parameters of the connected devices. The firmware 108 may then generate the signal 121 that includes basic information such as device ID, type, and connection status of the connected 1^{st} audio hardware 104-1.

The firmware 108 may include a communication interface module (not shown) to enable communication between the docking system 103 and the EC 110. Here, the EC 110 can directly communicate with the connected devices using appropriate protocols. For example, the communication interface module in the firmware 108 supports communication protocols such as USB, HDMI, I2C, SPI, Bluetooth, and GPIO to access the information about the associated devices. In this example, the communication interface module may be used by the EC 110 to obtain the device descriptors (e.g., USB device descriptors), configuration settings (e.g., audio codec capabilities, display resolutions), and status signals of the associated peripheral devices. In some embodiments, the firmware 108 may directly transmit the device information and events (e.g., device connected, device removed, or status change) to the EC 110 to trigger subsequent actions such as performing diagnostic tests and updating the device table 111.

Operating system (OS) 115 component may include the software platform to operate and manage the hardware and software components in the information handling system 102. The OS 115 may be connected to the docking system 103 via the EC 110. The OS 115 may use device drivers (not shown) to communicate with the peripheral devices via the EC 110. Device drivers are specialized software that allow the OS 115 to send commands or data to hardware components, including the EC 110. In an embodiment, the OS 115 may receive the device table 111, which includes the status (e.g., active, inactive, malfunctioning) and capabilities (e.g., audio, storage, display) of the detected peripheral devices (e.g., 1^{st} audio device hardware 104-1) and integrated devices (e.g., 3^{rd} audio device hardware 116-1). Here, the OS 115 may use tools like a Windows OS Device Manager, for example, to display and allow the user to use or interact with these devices.

For example, a user-entered device selection may be received by the OS 115. In this example, the EC 110 may facilitate communication between the OS 115 and the associated peripheral devices, such as, the 1^{st} audio device hardware 104-1 and 2^{nd} audio device hardware 104-2. The OS 115 may similarly display the 3^{rd} audio device hardware 116-1 and the 4^{th} audio device hardware 116-2 to the user.

Peripheral devices, such as, the 1^{st} audio device hardware 104-1 and 2^{nd} audio device hardware 104-2, or the integrated devices, such as, the 3^{rd} audio device hardware 116-1 and 4^{th} audio device hardware 116-2, may include audio devices, display devices, and the like. In an embodiment, each of these devices may include corresponding device IDs, capabilities, and other parameters, that can be detected by the EC 110. In an embodiment, the EC 110 may generate and update the device table 111 after a preconfigured time period or upon a detection of a triggering event. The event, for example, may include the detection of the connection of the peripheral device, such as, the 1^{st} audio device hardware 104-1 or the 2^{nd} audio device hardware 104-2. In another example, the attempt to reconnect for a threshold number of times may be representative of the event that can trigger the updating of the device table 111. In another example, the initialization of a detected disconnected device and the performance of the diagnostic testing may be representative of the event that can trigger the updating of the device table 111, etc.

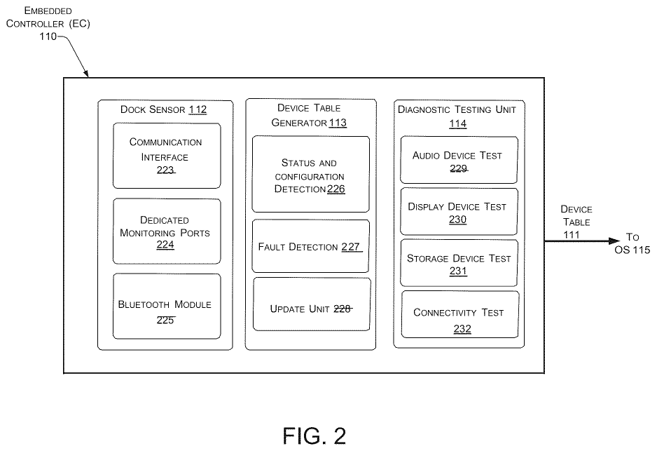

FIG. 2 illustrates an example block diagram of the EC 110 configured to generate and communicate the device table 111 to the OS 115 according to at least one embodiment of the present disclosure. The EC 110 may be configured to perform the generation and updating of the device table 111 independent of the OS 115. For example, the EC 110 may perform the real-time updating without receiving a command from the OS 115. In some cases, the OS 115 may issue an instruction command, and in response to the received instruction command, the EC 110 may be triggered to communicate to the OS 115 the updated device table 111. The EC 110 may utilize components to implement the sending of commands to the associated devices, control the associated devices, perform diagnostic tests on the devices, communicate in real time the device table 111 to the OS 115, implement instructions of the OS 115, and perform similar functionality to manage the peripheral and integrated devices.

In an embodiment, the dock sensor 112 may include a communication interface 223, dedicated monitoring ports 224, and a Bluetooth module 225. The dock sensor 112 may utilize these components to send a command (e.g., command 120) to the docking system 103, sense a signal (e.g., signal 121) from the docking system 103, directly control the associated devices, or perform diagnostic testing. For example, the communication interface 223 may support communication protocols such as USB, I2C, SPI, or other types of protocols that the docking system 103 may utilize for communication with the EC 110. In another example, the dedicated monitoring ports 224 may utilize the dedicated GPIO pins of the docking system 103 to detect changes in the voltage levels due to the association of one or more peripheral devices. Here, the dedicated monitoring ports 224 may detect the GPIO signals and communicate the detected GPIO signals to the device table generator 113 or the diagnostic testing unit 114 (via the signal 121) for further processing. In another example, the Bluetooth module 225 may handle discovery and communication with the Bluetooth-enabled devices (not shown). Here, the EC 110 may initially receive the identification of the Bluetooth-enabled devices that are associated with the docking system 103, and afterward, the Bluetooth module 225 may establish communication with these devices.

In an embodiment, the device table generator 113 may include a status and configuration detection 226, fault detection 227, and an update unit 228. The device table generator 113 may utilize these components to generate structured data (device table 111) that can be communicated to the OS 115 for further processing or to trigger the OS 115 to communicate one or more command instructions that can be performed by the EC 110. For example, upon a detection of an audio device associated with the docking system 103 (via signal 121), the status and configuration detection 226 may retrieve descriptors from the associated audio device e.g., device type, capabilities, and supported formats. In the case of a display device, the status and configuration detection 226 may collect the supported resolutions, color depths, and the like. In this example, the fault detection 227 may further receive diagnostic testing results from the diagnostic testing unit 114. The data collected by the fault detection 227 may be used to update (e.g., using the update unit 228) the generated device table 111 as described herein.

In an implementation, the diagnostic testing unit 114 may include an audio test device test 229, a display device test 230, a storage device test 231, and a connectivity test 232. The diagnostic testing unit 114 may utilize these components to continuously send status updates and other data to the update unit 228. The update unit 228 of the device table generator 113 may then utilize the received data for updating the status and configuration (i.e., device table 111) of the associated devices.

For example, upon detection of an associated audio device, the audio device test 229 may send a tone signal through the USB, HDMI, GPIO, or Bluetooth to test the sound output of the audio device or verify microphone input. For display devices, the display device test 230 may send test signals to test and verify the resolution, color depth, and refresh rates of these devices. For storage devices, the storage device test 231 may send test signals to verify reading and writing capabilities of the storage devices associated with the docking system. In this example, the connectivity test 232 may ensure stable communication between EC 110 and the docking system 103 and the associated devices by constantly sending test signals to verify signal integrity and transfer speeds.

In some embodiments, the diagnostic testing unit 114 may generate error codes (not shown) when a device fails a test or fails to respond to a test signal. In response to the error codes, the EC 110 may be configured to perform recovery actions such as attempting to reconnect, reset, or initialize the device. After a threshold number of attempts to reconnect (e.g., three times), for example, the update unit 228 may update the device table 111 to include the status or configuration of the device based on the attempted recovery action. In another example, the EC 110 may perform device initialization rather than attempting to reconnect. In this example, the EC 110 may perform another diagnostic test before updating the device table based on the results of the latest diagnostic testing. The ability of the EC 110 to report in real time the status or configuration of these devices may promote efficient use of the same.

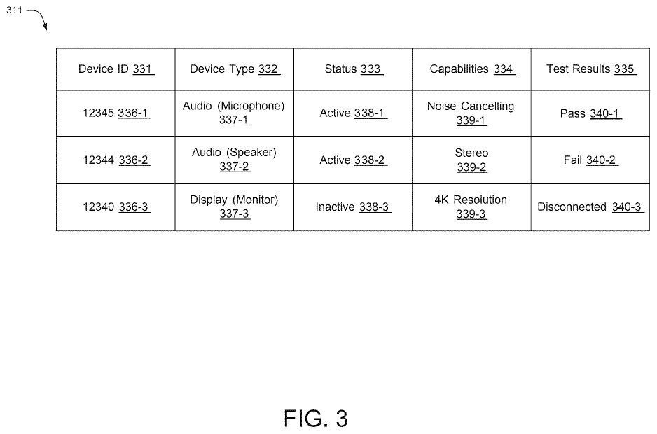

FIG. 3 illustrates an example device table 311 that can be generated by the EC 110 according to at least one embodiment of the present disclosure. In an embodiment, the generated device table 311 may include a device ID 331, a device type 332, a status 333, capabilities 334, and test results 335. The EC 110 may initially establish communication (e.g., via command 120) with the docking system 103 and after establishing communication, the EC 110 may sense or detect the signal 121 from the docking system 103. The sensed signal 121 may be parsed to identify, for example, the device ID 331 and the device type 332 of associated devices.

For example, the device ID 331 from the sensed signal 121 may include “12345” 336-1 while the device type 332 associated to this device (“12345” 336-1) can include an audio (microphone) 337-1. Here, the sensed signal 121 may further indicate an “active” 338-1 device status (status 333), “noise cancelling” 339-1 device capabilities (capabilities 334), and a “pass”340-1 test result (test results 335) that indicates the availability of the device. The active” 338-1 device status (status 333) and the “pass” 340-1 test result (test results 335) can be representative of responses from separate command signals received by this device.

As shown, another associated device “12344” 366-2 can be derived from the sensed signal 121. For example, the device “12344” 366-2 is determined to include an audio (speaker) 337-2 as the device type (device type 332), on active state (“active” 338-2), includes “stereo”339-2 capabilities (capabilities 334), and a “fail” 340-2 (test results 335). In an embodiment, and in response to the detected failed test results (“fail” 340-2), the EC 110 may be configured to reconnect with the device 12344 336-2 for a threshold number of times (e.g., three times) before the EC 110 can perform the updating of the device table 311. In another embodiment, and in response to the same detected failed test results (“fail” 340-2), the EC 110 may be configured to initialize the device 12344 336-2 and perform another diagnostic test before the EC 110 performs the updating of the device table 311.

In an embodiment, the EC 110 may store or flag the recent device used by the information handling system 102. In this embodiment, in case of a detected disconnection of the most recently used device (i.e., flagged device), the EC 110 may be configured to prioritize reconnection with the same device. For example, the information handling system 102 recently used the device “12340” 336-3 before the information handling system 102 was disconnected from the docking system 103. The device “12340” 336-3 is a display monitor (display 337-3) and has 4K resolution 339-3 (capabilities 334). In this example, after determining the “disconnected” 340-3 test results 335 of the device “12340” 336-3, the EC 110 may be configured to prioritize reconnection with the same device “12340” 336-3. In some embodiments, the EC 110 may also initialize the same device “12340” 336-3 and perform another diagnostic test before the EC 110 attempts to reconnect.

In an embodiment, the device table 311 may also include the structure data of the integrated devices, such as the 3^{rd} audio device hardware 116-1 and the 4^{th} audio device hardware 116-2 as described in FIG. 1.

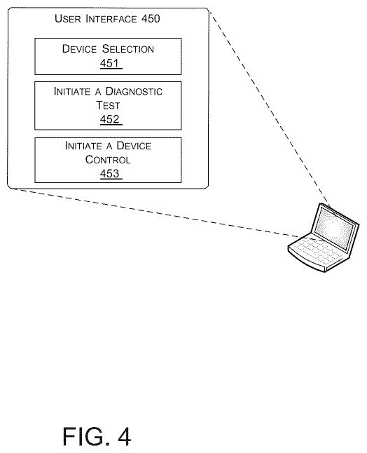

FIG. 4 illustrates an example user interface 450 that displays device selections according to at least one embodiment of the present disclosure. In an embodiment, the user interface 450 may present options for device selection 451, initiate a diagnostic test 452, or initiate a device control 453. In this embodiment, a user's selection (device selection 451) may specify a particular device available for use by the information handling system 102. Here, the EC 110 may receive the user-entered selection and facilitate communication between the OS 115 and the selected device.

In some embodiments, a user's selection may also include the particular type of diagnostic test (e.g., initiate a diagnostic test 452) to be performed on the selected device available for use by the information handling system 102. For example, the selected diagnostic test includes testing of a microphone or audio device. In this example, the user may also select to directly control (e.g., initiate a device control) the selected device.

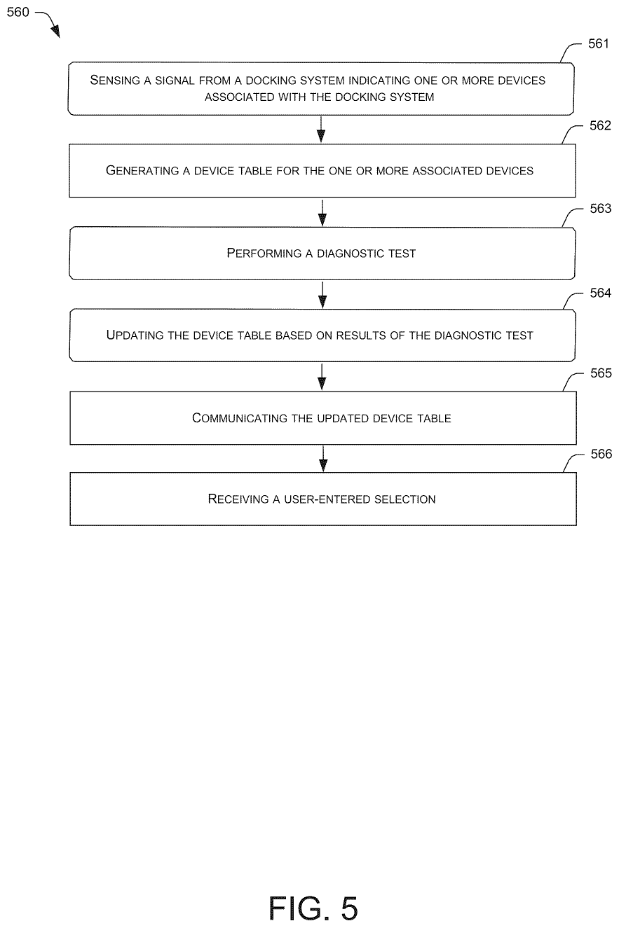

FIG. 5 is a flow diagram of a method 560 for reporting external devices to users according to at least one embodiment of the present disclosure, starting at step 561. It will be readily appreciated that not every method step set forth in this flow diagram is always necessary, and that certain steps of the methods may be combined, performed simultaneously, in a different order, or perhaps omitted, without varying from the scope of the disclosure. FIGS. 1-2 may be employed in whole, or in part, by a controller (EC 110) of the information handling system 102 of FIG. 1, or any other type of controller, device, module, processor, or any combination thereof, operable to employ all, or portions of, the method of FIG. 5.

At step 561, the EC 110 (controller) may sense a signal from a docking system indicating one or more devices associated with the docking system.

At step 562, the EC 110 may generate a device table for the one or more associated devices. In some embodiments, the associated devices may include the devices that were already incorporated to the information handling system.

At step 563, the EC 110 may perform a diagnostic test on the one or more associated devices.

At step 564, the EC 110 may update the device table based on results of the performed diagnostic test. For example, results may indicate a disconnected device, fail status in response to the inability of the device to satisfy the requirement of the diagnostic test, pass status, and the like. In this example, the EC 110 may also perform another diagnostic test after the initialization of the disconnected device as described above.

At step 565, the EC 110 may communicate the updated device table to an operating system (OS) of the information handling system. For example, the EC 110 may independently and continuously monitor the associated devices and transmit in real-time the updated device table to the OS. In some cases, the EC 110 may transmit the updated device table in response to a received request from the OS. Additionally, the EC 110 may transmit the updated device table upon the detection of a triggering event as described herein.

At step 566, the EC 110 may receive a user-entered device selection, wherein the EC 110 facilitates communication between the selected device and the OS.

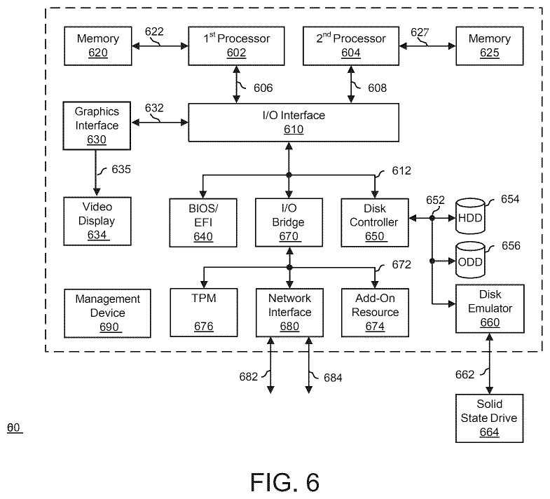

FIG. 6 shows a generalized embodiment of an information handling system 600 according to an embodiment of the present disclosure. Information handling system 600 may be substantially similar to information handling system 102 of FIG. 1 that implements or includes the EC 110. For the purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operate to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656, a disk emulator 660 connected to an external solid state drive (SSD) 664, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 664, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 4394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off of a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A system comprising:
a docking system;
an information handling system further comprising:
an operating system (OS); and
an embedded controller (EC) that is configured to:
sense a signal from the docking system indicating one or more devices associated with the docking system;
generate a device table for the one or more associated devices;
perform a diagnostic test on the one or more associated devices;
update the device table based on results of the diagnostic test;
communicate the updated device table to the OS; and
receive a user-entered device selection, wherein the EC facilitates a communication between the selected device and the OS.

2. The system of claim 1, wherein the EC is further configured to:
transmit a command to the docking system to establish connection with the associated devices; and
manage operations of the one or more associated devices based on the sensed signal.

3. The system of claim 1, wherein the EC is further configured to:
transmit a command to the one or more associated devices; and
verify power-on condition and configuration of the one or more associated devices based on the transmitted command.

4. The system of claim 1, wherein the EC is further configured to:
detect a failure in a particular associated device based on the results of the diagnostic test; and
attempt to reconnect to the particular associated device for a threshold number of times,
wherein the device table is updated based on the attempt to reconnect with the particular associated device.

5. The system of claim 1, wherein the EC is further configured to:
detect a failure in a particular associated device based on the results of the diagnostic test;
initialize the particular associated device;
perform another diagnostic test on the initialized associated device, wherein the device table is updated based on results of the performed another diagnostic test.

6. The system of claim 1, wherein the device table includes at least one of the following parameters for each associated device: device ID, device type, status, capabilities, and diagnostic results.

7. The system of claim 6, wherein the EC is configured to perform continuous monitoring of the associated one or more devices and provide real-time updates to the OS.

8. The system of claim 1, wherein the EC is configured to generate and update the device table independently of the OS.

9. The system of claim 8, wherein the OS is configured to manage the associated one or more devices based on the updated device table.

10. A method for docking an information handling system to a docking system, the method comprising:
sensing, by a controller of the information handling system, a signal from a docking system indicating one or more devices associated with the docking system;
generating, by the controller, a device table of the one or more associated devices;
performing, by the controller, a diagnostic test on the one or more associated devices;
updating, by the controller, the device table based on results of the performed diagnostic test;
communicating the updated device table to an operating system (OS) of the information handling system; and
receiving a user-entered device selection, wherein the controller facilitates a communication between the selected device and the OS.

11. The method of claim 10, the performing a diagnostic test of the one or more associated devices, the method further comprises:
transmitting, by the controller, a command to the docking system; and
managing operations of the one or more associated devices based on the sensed signal.

12. The method of claim 10, the performing a diagnostic test of the one or more associated devices, the method further comprises:
transmitting, by the controller, a command to the one or more associated devices; and
verifying power-on condition and configuration of the one or more associated devices based on the transmitted command.

13. The method of claim 10 further comprising:
detecting a failure in a particular associated device based on the results of the diagnostic test; and
attempting to reconnect to the particular associated device for a threshold number of times,
wherein the updating of the device table is based on the attempt to reconnect with the particular associated device.

14. The method of claim 10 further comprising:
detecting a failure in a particular associated device based on the results of the diagnostic test;
initializing the particular associated device;
performing another diagnostic test on the initialized associated device, wherein the updating of the device table is based on results of the performed another diagnostic test.

15. The method of claim 10, wherein the device table includes a device ID, device type, status, and capabilities of each associated device.

16. The method of claim 15 further comprising:
storing a recently used device;
detecting a disconnection of the recently used device; and
prioritizing reconnection with the disconnected, recently used device.

17. An information handling system comprising:
a memory; and
a controller to communicate with the memory, the controller to:
sense a signal from a docking system indicating one or more devices associated with the docking system;
generate a device table for the one or more associated devices;
perform a diagnostic test on the one or more associated devices;
update the device table stored in the memory based on results of the diagnostic test;
communicate the updated device table to the OS; and
receive a user-entered device selection, wherein the EC facilitates a communication between the selected device and the OS.

18. The system of claim 17, wherein the controller is further configured to:
transmit a command to the docking system to establish a connection with the associated devices; and
manage operations of the one or more associated devices based on the sensed signal.

19. The system of claim 17, wherein the controller is further configured to:
detect a failure in a particular associated device based on the results of the diagnostic test; and
attempt to reconnect to the particular associated device for a threshold number of times,
wherein the device table is updated based on the attempt to reconnect with the particular associated device.

20. The system of claim 17, wherein the controller is further configured to:
detect a failure in a particular associated device based on the results of the diagnostic test;
initialize the particular associated device;
perform another diagnostic test on the initialized associated device, wherein the device table is updated based on results of the diagnostic test.
